(19) United States
(12) Patent Application Publication
(10) Pub. No.: US 2026/0211191 A1
(43) Pub. Date: Jul. 23, 2026

(54) HARDENED CONNECTOR

(71) Applicant: CommScope Technologies LLC, Claremont, NC (US)

(72) Inventors: Levi T. MERRICK, Bloomington, MN (US); Yu LU, Eden Prairie, MN (US); Ryan KOSTECKA, Waconia, MN (US)

(73) Assignee: CommScope Technologies LLC, Claremont, NC (US)

(21) Appl. No.: 19/136,947

(22) PCT Filed: Nov. 15, 2023
(86) PCT No.: PCT/US2023/079843

§ 371 Date: Jun. 9, 2025

Related U.S. Application Data
(60) Provisional application No. 63/431,516, filed on Dec. 9, 2022.

(51) Int. Cl. G02B 6/38

(52) U.S. Cl. CPC G02B 6/3891; G02B 6/3825; G02B 6/3831; G02B 6/3849; G02B 6/3851; G02B 6/3871; G02B 6/3881

(57) ABSTRACT

An optical connector or a converter for an optical connector having a coupling nut such as a bayonet-style coupling nut. The optical connector or the optical converter are configured such that the coupling nut has a limited range of rotation defined between stop surfaces. The range of rotation can be less than 90 degrees. The stop surfaces can be provided by a guide slot defined by a first radial width portion and a second radial width portion.

### CROSS-REFERENCE TO RELATED APPLICATION

This application is being filed on Nov. 15, 2023, as a PCT International Application and claims the benefit of U.S. Provisional Application No. 63/431,516, filed Dec. 9, 2022, the disclosure of which is hereby incorporated by reference in its entirety.

### TECHNICAL FIELD

The present disclosure relates generally to fiber-optic connectivity. More particularly, the present disclosure relates to fiber optic connectors involving the use of a converter to adapt a fiber-optic plug with a first keyed profile to match a fiber-optic receptacle with a second, incompatible keyed profile, thereby enabling effective connectivity.

### BACKGROUND

Fiber optic communication systems are becoming prevalent in part because service providers want to deliver high bandwidth communication capabilities (e.g., data and voice) to customers. Fiber optic communication systems employ a network of fiber optic cables to transmit large volumes of data and voice signals over relatively long distances. Optical fiber connectors are an important part of most fiber optic communication systems. Fiber optic connectors enable two optical fibers to be quickly optically connected without requiring a splice. Fiber optic connectors can be used to optically interconnect two lengths of optical fiber. Fiber optic connectors can also be used to interconnect lengths of optical fiber to passive and active equipment.

A typical fiber optic connector includes a ferrule assembly supported at a distal end of a connector housing. A spring is used to bias the ferrule assembly in a distal direction relative to the connector housing. The ferrule functions to support an end portion of at least one optical fiber (in the case of a multi-fiber ferrule, the ends of multiple fibers are supported). The ferrule has a distal end face at which a polished end of the optical fiber is located. When two fiber optic connectors are interconnected, the distal end faces of the ferrules abut one another, and the ferrules are forced proximally relative to their respective connector housings against the bias of their respective springs. With the fiber optic connectors connected, their respective optical fibers are coaxially aligned such that the end faces of the optical fibers directly oppose one another. In this way, an optical signal can be transmitted from optical fiber to optical fiber through the aligned end faces of the optical fibers. For many fiber optic connector styles, alignment between two fiber optic connectors is provided through the use of an intermediate fiber optic adapter.

Ruggedized (i.e., hardened) fiber optic connection systems include fiber optic connectors and fiber optic adapters suitable for outside environmental use. These types of systems are typically environmentally sealed and include robust fastening arrangements suitable for withstanding relatively large pull loading and side loading. Example ruggedized fiber optic connection systems are disclosed by U.S. Pat. Nos. 7,467,896; 7,744,288; and 8,556,520.

It will be appreciated that a number of different types of ruggedized fiber optic connectors are available for outside environmental use. International Publication Nos. WO2015/028433; WO2020/236512; and WO2021/041305 disclose systems for making fiber optic connectors in which a number of different ruggedized outer assemblies having different form-factors or configurations can be selectively mounted on a pre-terminated cable such that the pre-terminated cable can be customized to be compatible with a particular style or type of fiber optic connector or fiber optic adapter.

### SUMMARY

Aspects of the present disclosure relate to the meeting of a fiber-optic plug having a first keyed profile with a fiber-optic receptacle having a second keyed profile, wherein the first keyed profile is non-compatible with the second keyed profile, and wherein a converter is operably coupled to the fiber-optic plug to convert the first keyed profile to the second keyed profile, thereby enabling a functional mating between the fiber-optic plug and the fiber-optic receptacle.

One aspect of the present disclosure relates to a converter for an optical plug, including a converter body having an outer surface defining a guide slot extending along a longitudinal axis of the converter body, the guide slot defined by a first radial width portion and a second radial width portion, and a converter nut defining a through bore through which a portion of the converter body passes to enable the converter nut to rotate relative to the converter body, wherein an interior surface of the throughbore defines an inwardly extending guide member, the guide member confined to the guide slot defined by the converter body when the converter nut is operably coupled to the converter body, whereupon positioning the guide member within the second radial width portion of the guide slot limits rotation of the converter nut relative to the converter body to an angle of less than 90°.

In one embodiment, the converter further includes a dust cap. In one embodiment, the dust cap defines one or more bayonet slots configured to receive coupling pins of the converter nut to rotationally orient the converter nut relative to the dust cap. In one embodiment, the dust cap defines one or more alignment projections configured to interface with the notch portion of the converter body to rotationally orient the converter body relative to the dust cap. In one embodiment, the converter is operably coupleable to a fiber-optic plug to convert the fiber-optic plug from a first keyed profile to a second keyed profile.

Another aspect of the present disclosure relates to a plug and converter assembly, including a plug body including a turn to secure fastener defining a snap fit receptacle, and a converter body defining a resilient snap fit member configured to be at least partially received in the snap fit receptacle, the resilient snap fit member arranged as a cantilevered member operably coupled to an exterior surface of the converter body at a first connection point and a second connection point, the first connection point oriented in a radial direction relative to the converter body and the second connection point oriented in a longitudinal direction relative to the converted body, the longitudinal direction being substantially orthogonal to the radial direction.

In one embodiment, the converter body further defines one or more axial stops configured to be received within one or more corresponding stop receptacles defined by the plug body to inhibit movement in the longitudinal direction between the plug body and the converted body. In one embodiment, the one or more axial stops are received within the one or more corresponding stop receptacles through partial rotation of the converted body relative to the plug body. In one embodiment, receipt of the resilient snap fit member of the converted body within the snap fit receptacle of the plug body serves to inhibit back rotation of the converted body relative to the plug body.

In one embodiment, the assembly further includes a converter nut defining a through bore through which a portion of the converter body passes to enable the converter nut to rotate relative to the converter body. In one embodiment, the assembly further includes a dust cap. In one embodiment, the dust cap defines one or more bayonet slots configured to receive coupling pins of the converter nut to rotationally orient the converter nut relative to the dust cap. In one embodiment, the dust cap defines one or more alignment projections configured to interface with the notch portion of the converter body to rotationally orient the converter body relative to the dust cap. In one embodiment, the converter converts the plug body from a first keyed profile to a second keyed profile.

Another aspect of the present disclosure relates to a plug and converter assembly, including a plug body including a connector core defining an elongate key extending along a longitudinal axis of the plug body, and a converter operably coupleable to the plug body, the converter comprising a converter body, a converter nut and a dust cap, the converter body defining a keyway configured to receive the elongate key of the plug body to rotationally orient the plug body relative to the converter body, the dust cap defining one or more bayonet slots configured to receive coupling pins of the converter nut to rotationally orient the converter nut relative to the dust cap, and the dust cap further defining one or more alignment projections configured to interface with a notch portion of the converter body to rotationally orient the converter body relative to the dust cap.

In one embodiment, the converter body further defines one or more axial stops configured to be received within one or more corresponding stop receptacles defined by the plug body to inhibit movement in the longitudinal direction between the plug body and the converted body. In one embodiment, the one or more axial stops are received within the one or more corresponding stop receptacles through partial rotation of the converted body relative to the plug body. In one embodiment, the plug body defines a snap fit receptacle, and the converter body defines a snap fit member configured to be at least partially received in the snap fit receptacle. In one embodiment, the resilient snap fit member is arranged as a cantilevered member operably coupled to an exterior surface of the converter body at a first connection point and a second connection point, the first connection point oriented in a radial direction relative to the converter body and the second connection point oriented in a longitudinal direction relative to the converted body, the longitudinal direction being substantially orthogonal to the radial direction in one embodiment, the converter converts the plug body from a first keyed profile to a second keyed profile.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is an exploded, perspective view depicting a fiber-optic plug having a first keyed profile, fiber optic receptacle having a second keyed profile, and a converter configured to convert the first keyed profile to the second keyed profile, in accordance with an embodiment of the disclosure.

FIG. 2 is a perspective view depicting the fiber-optic plug, converter and fiber-optic receptacle of FIG. 1 wherein the fiber-optic plug-in converter are in an assembled configuration, in accordance with an embodiment of the disclosure.

FIG. 3 is a perspective view depicting a fiber-optic plug, in accordance with embodiments of the disclosure.

FIG. 4 is a cross-sectional view depicting a fiber-optic plug, in accordance with an embodiment of the disclosure.

FIG. 5 is a close-up, cross-sectional view of a turn-to-secure fastener of a fiber-optic plug, in accordance with an embodiment of the disclosure.

FIG. 6 is a perspective view of a fiber-optic receptacle and fiber optic plug having a second keyed profile, in accordance with an embodiment of the disclosure.

FIG. 7 is a cross-sectional view depicting a fiber-optic plug and converter in an assembled configuration, in accordance with an embodiment of the disclosure.

FIG. 8 is an exploded, perspective view depicting a converter, in accordance with an embodiment of the disclosure.

FIG. 9 is a perspective view depicting the converter of FIG. 8 in an assembled configuration, in accordance with an embodiment of the disclosure.

FIG. 10 is a perspective view depicting a converter body, in accordance with an embodiment of the disclosure.

FIG. 11 is a cross-sectional, perspective view depicting the converter body of FIG. 10, in accordance with an embodiment of the disclosure.

FIG. 12 is a perspective view depicting a converter body, in accordance with an embodiment of the disclosure.

FIG. 13 is a different perspective view depicting a converter body, in accordance with an embodiment of the disclosure.

FIG. 14 is a perspective view depicting a converter nut, in accordance with an embodiment of the disclosure.

FIG. 15 is a cross-sectional, perspective view depicting the converter nut of FIG. 14, in accordance with an embodiment of the disclosure.

FIG. 16A is a perspective view depicting a converter nut and converter body, in accordance with an embodiment of the disclosure.

FIG. 16B is an alternative perspective view depicting a converter nut and converter body, in accordance with an embodiment of the disclosure.

FIG. 17 is a cross-sectional view depicting a limited rotation of a converter nut relative to a converter body, in accordance with an embodiment of the disclosure.

FIG. 18 is a perspective view of a dust cap, in accordance with an embodiment of the disclosure.

FIG. 19 is a cross-sectional, perspective view depicting the dust cap of FIG. 16, in accordance with an embodiment of the disclosure.

### DETAILED DESCRIPTION

Aspects of the present disclosure relate to enclosures, systems, methods, designs, and assemblies for converting (e.g., modifying, retrofitting, etc.) a first type of hardened fiber-optic plug to be compatible with and to be received within the opening of a second type of hardened fiber optic jack or receptacle. In one example, the first type of hardened fiber optic plug is a Prodigy™ type fiber-optic connector sold by CommScope Technologies, LLC of Hickory, North Carolina, USA, and the second type of hardened fiber-optic receptacle is a SlimConnect™ type fiber-optic receptacle sold by Furukawa Electric of Tokyo, Japan.

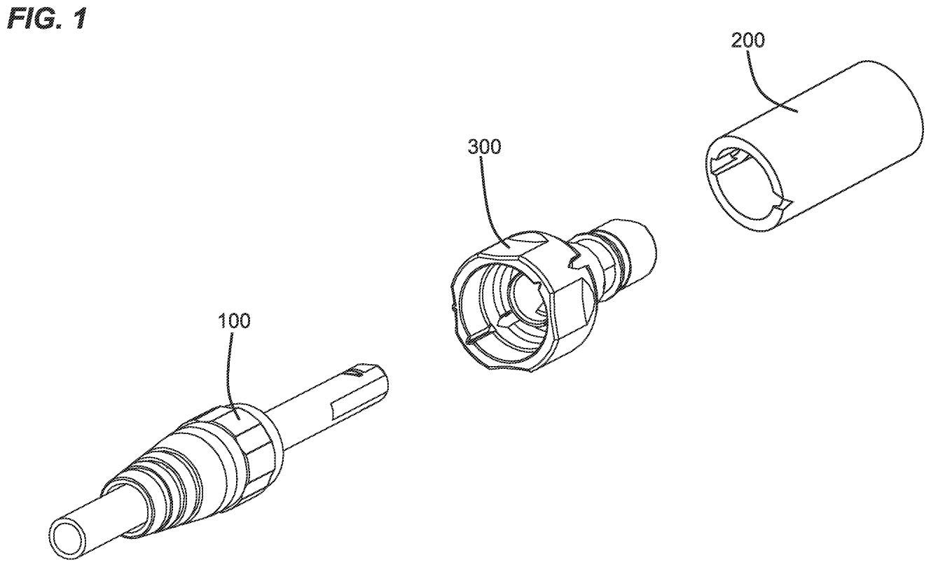

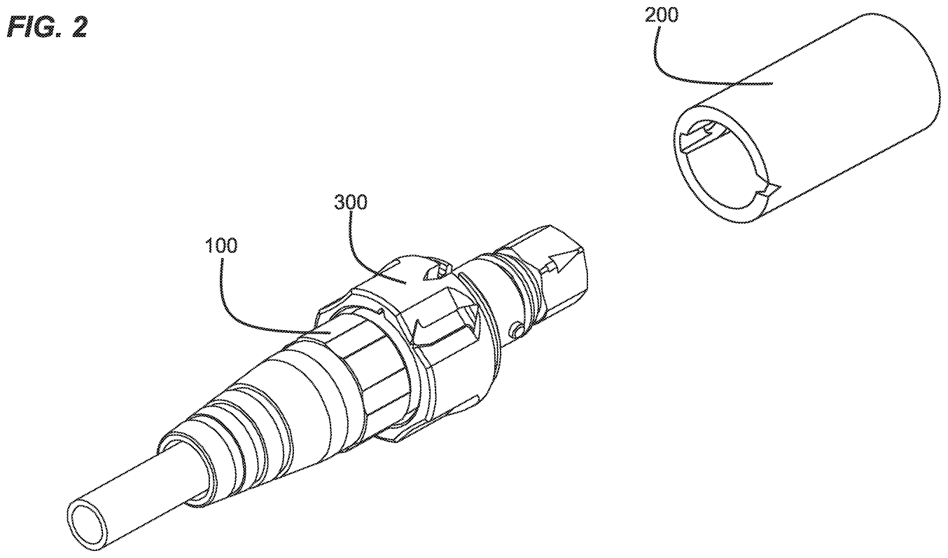

Referring to FIG. 1, a fiber-optic plug 100 having a first keyed profile, and a fiber-optic receptacle 200 having a second keyed profile are depicted in accordance with an embodiment of the disclosure. As can be seen, the first keyed profile is non-compatible with the second keyed profile, in that the various retention features defined by the fiber-optic plug 100 that would otherwise secure the fiber-optic plug 100 to a corresponding receptacle have no retention effect on the fiber-optic receptacle 200 with the second keyed profile. To address this problem, Applicants of the present disclosure have developed a converter 300 configured to convert the first keyed profile of the fiber-optic plug 100 into the second keyed profile compatible with the fiber-optic receptacle 200. Accordingly, as depicted in FIG. 2, assembling the converter 300 with the fiber-optic plug 100 enables the fiber-optic plug 100/converter 300 assembly to be received and retained by the fiber-optic receptacle 200. Although the terms plug, converter and receptacle are used throughout the disclosure for clarity, each of these terms may be interchanged with the terms connector, adapter, or retainer.

Reference will now be made in detail to exemplary aspects of the present disclosure that are illustrated in the accompanying drawings. Wherever possible, the same reference numbers will be used throughout the drawings to refer to the same or like parts.

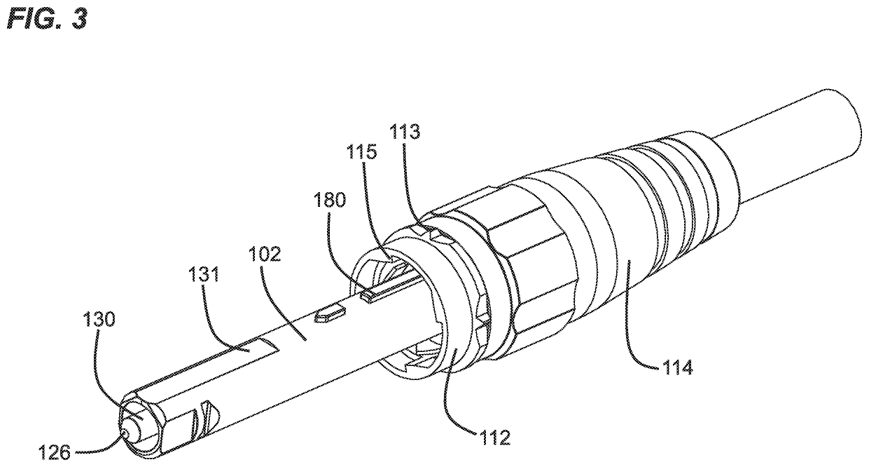

Referring to FIG. 3, a fiber-optic plug 100 having a first keyed profile is depicted in accordance with an embodiment of the disclosure. FIG. 2 depicts a cross-sectional view of the fiber-optic plug 100 of FIG. 1. As depicted, the fiber-optic plug 100 can include a connector core 102 terminating one end of a fiber-optic cable 104. For example, in one embodiment, the fiber-optic cable 104 can be attached and secured to the connector core 102 at a cable attachment end 106 of the connector core 102. The fiber-optic cable 104 can include an outer jacket 108, which can be secured to the cable attachment end 106 of the connector core 102 by a sleeve 110, such as a shape memory sleeve (e.g., heat shrink sleeve). In certain examples, the sleeve 110 can include an interior layer of adhesive for bonding the sleeve 110 to the outer jacket 108 and to the connector core 102.

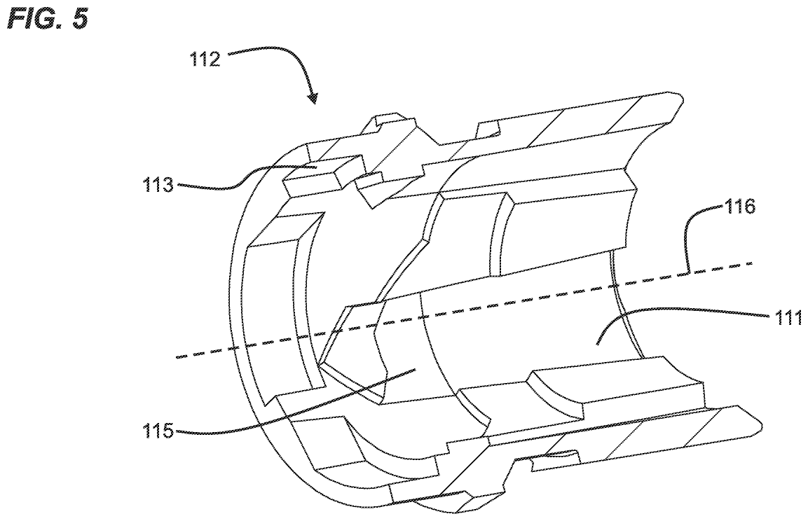

In some embodiments, the fiber-optic plug 100 includes a turn-to-secure fastener 112 defining one or more retaining features generally configured to aid in retaining the fiber optic plug 100 to a corresponding receptacle. With additional reference to FIG. 5, the turn-to-secure fastener 112 can define an internal bore 111, which can define one or more stop receptacles 115 configured to receive one or more corresponding axial stops (e.g., triangular projections, etc.), thereby inhibiting axial movement of the fiber-optic plug 100 relative to the receptacle along a longitudinal axis 116 of the fiber-optic plug 100. In some embodiments, the turn-to-secure fastener 112 is partially rotated relative to the corresponding receptacle in order to secure the one or more axial stops within the stop receptacles 115 of the fiber-optic plug 100.

To inhibit back rotation of the turn-to-secure fastener 112 relative to the corresponding receptacle, in some embodiments, the internal bore 111 can further define one or more snap fit receptacles 113, generally configured to receive one or more resilient snap fit members defined by a corresponding receptacle. With the one or more resilient snap fit members of the receptacle seated within the snap fit receptacles 113, back rotation of the turn-to-secure fastener 112 relative to the corresponding receptacle is inhibited. Aspects regarding the interaction between the one or more retaining features (e.g., snap fit receptacles 113 and stop receptacles 115) are further described in connection with the corresponding features of the converter 300.

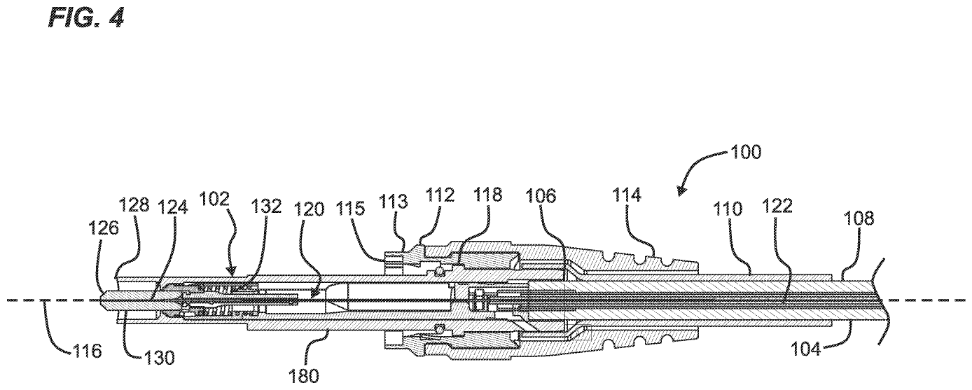

With continued reference to FIGS. 3-4, the turn-to-secure fastener 112 can be rotatably mounted to the connector core 102, with a strain relief boot 114 mounted on the turn-to-secure fastener 112. For example, the turn-to-secure fastener 112 can be mounted over the connector core 102, such that the turn-to-secure fastener 112 can be turned (e.g., rotated) relative to the connector core 102 about the longitudinal axis 116. The turn-to-secure fastener 112 can be captured axially between an outer stop 118 (e.g., a shoulder) of the connector core 102 and the front end of the sleeve 110, such that the turn-to-secure fastener 112 is retained on the connector core 102. In some embodiments, the strain relief boot 114 can be turned in unison with the turn-to-secure fastener 112 about longitudinal axis 116.

The fiber-optic plug 100 can include an optical fiber structure 120, including a first section 122 routed longitudinally through the outer jacket 108 of the fiber-optic cable 104, and a second section 124 routed through the connector core 102. The second section 124 of the optical fiber structure 120 can define a fiber tip 126 at a front plug end 128 of the connector core 102. A front portion of the second section 124 is secured and supported within a ferrule 130. The ferrule 130 can be spring biased in a forward direction relative to the connector core 102 by a spring 132. For example, in some embodiments, the connector core 102 can include an inner body having a front end that functions as a spring stop, and a rear end that can includes structure for use in securing one or more strength members of the fiber-optic cable 104 to the connector core 102. In embodiments, the front plug end 128 can optionally have a form factor compatible with an SC type fiber-optic adapter, but could have other form factors as well, such as an LC connector form factor compatible with an LC type fiber-optic adapter.

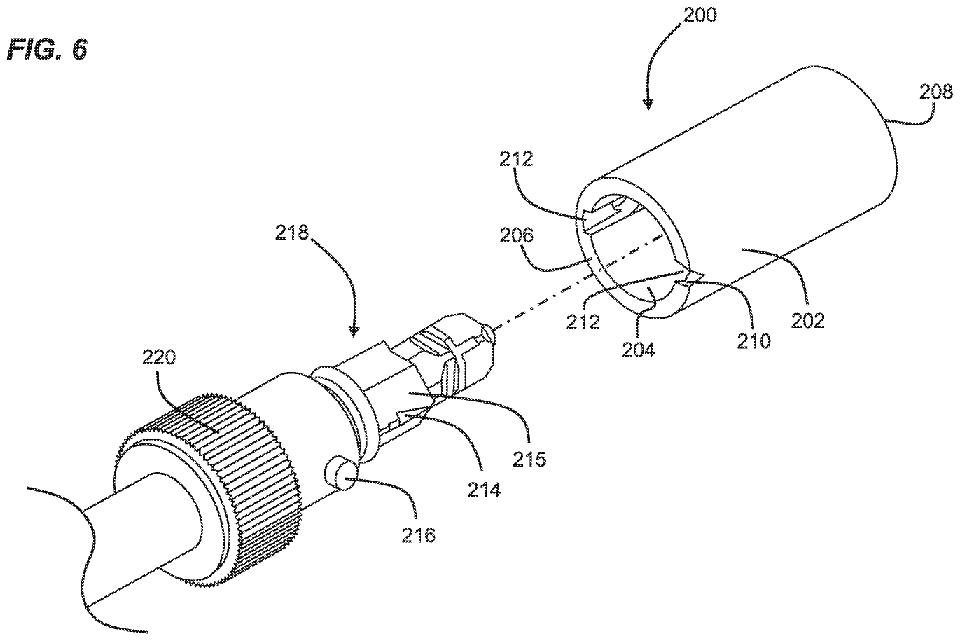

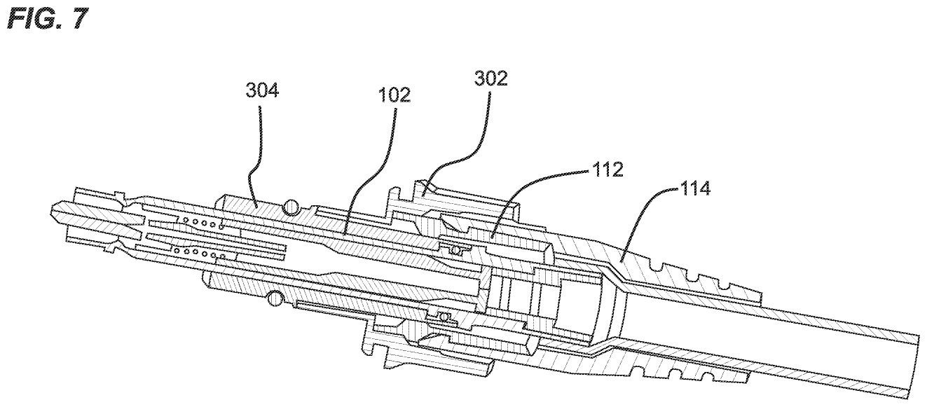

Referring to FIG. 6, a fiber-optic receptacle 200 (and corresponding plug 218) having a second keyed profile, that is noncompatible with the first keyed profile, is depicted in accordance with an embodiment of the disclosure. As depicted, the fiber-optic connector 200 can include a connector body 202 defining an interior bore 204 extending between a first end 206 and a second end 208. The interior bore 204 can define one or more bayonet slots 212 (configured to receive one or more coupling pins 216 of a corresponding plug 218).

In operation, plug 218 can be coupled to the fiber-optic connector 200 by inserting the plug 218 slightly into the first end 206 of the connector body 202. To aid in alignment, an indicator 214 positioned on an exterior of the plug 218 can be aligned with a notch 210 defined by the connector body 202, thereby ensuring that a keyed surface 215 of the plug 218 is properly oriented with respect to a corresponding keyed receptacle defined by the interior bore 204. Next, the coupling nut 220 is rotated (e.g., clockwise) until the coupling pins 216 on the coupling nut 220 align with the one or more bayonet slots 212 formed in the first end 206 of the interior bore 204. The plug 218 is pushed forward into the fiber-optic connector 200 until the coupling pins 216 bottom in the bayonet slots 212, and the coupling nut 220 can no longer be rotated.

To address incompatibility between the first keyed profile (of fiber-optic plug 100) and the second keyed profile (of fiber-optic receptacle 200), Applicants of the present disclosure have developed a converter 300 configured to selectively mount to the fiber-optic plug 100, thereby enabling a compatible mating between the fiber-optic plug 100 and the otherwise noncompatible fiber-optic receptacle 200.

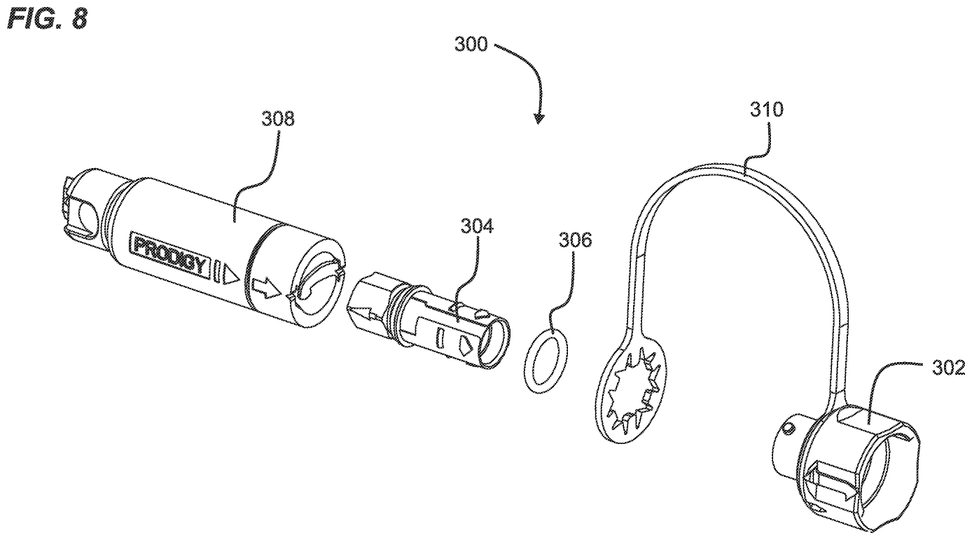

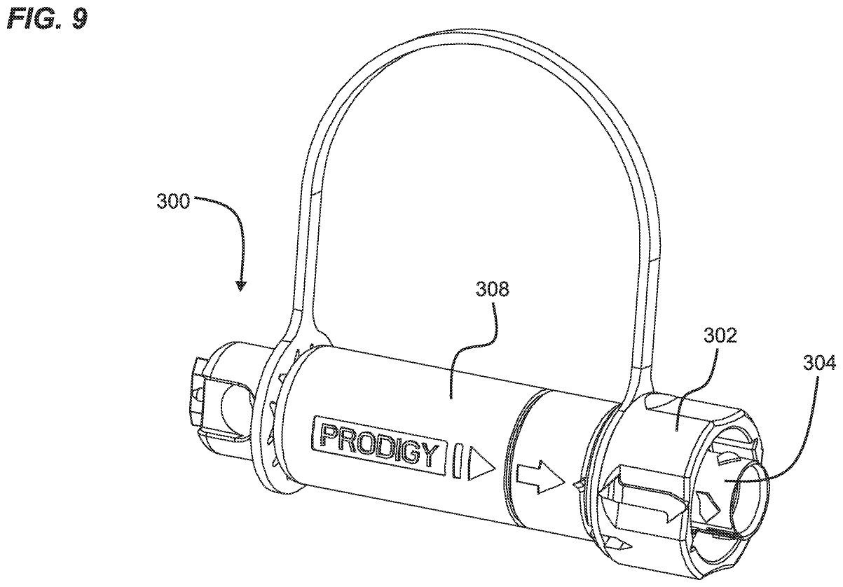

Referring to FIG. 8, an exploded view of the converter 300 is depicted in accordance with an embodiment of the disclosure. FIG. 9 depicts the converter 300 of FIG. 8 in an assembled state. In some embodiments, the converter 300 comprises a converter nut 302, converter body 304, O-ring 306, dust cap 308, and lanyard 310, although some components (e.g., the O-ring 306, dust cap 308, and lanyard 310) may be considered optional.

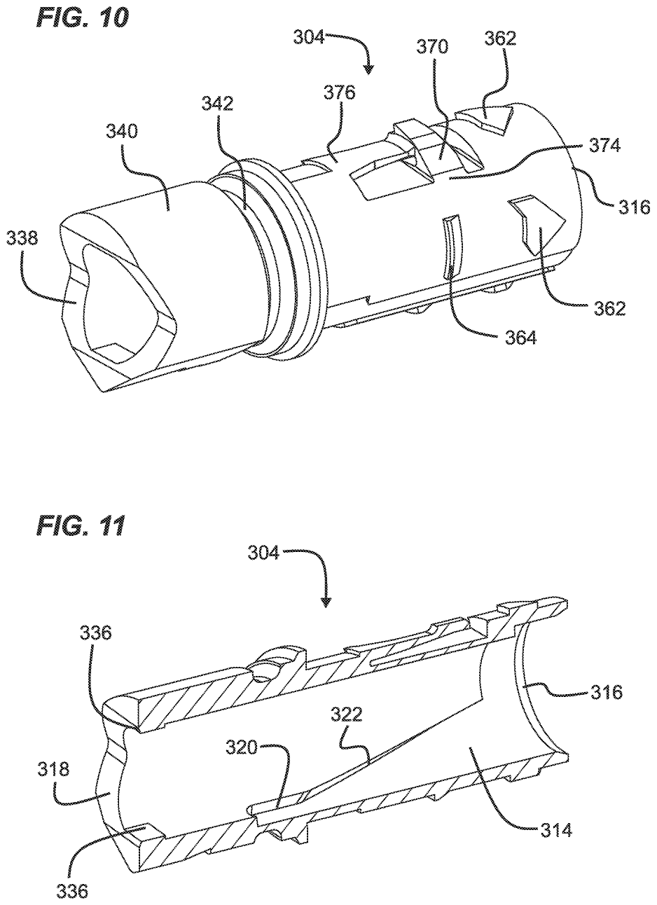

With additional reference to FIGS. 10-13, the converter body 304 can define a throughbore 314 extending between a first end 316 and a second end 318. An interior surface of the throughbore 314 can generally be shaped to receive the connector core 102 of the fiber-optic plug 100. For example, as depicted in FIG. 11, in one embodiment, the throughbore 314 can be substantially cylindrical in shape, with one or more optional protrusions 336 extending inwardly from the interior surface of the throughbore 314 to create an interference fit between corresponding flat surfaces 131 of the connector core 102.

As further depicted in FIG. 11, the throughbore 314 can define a keyway 320 for receiving an elongate key 180 of the connector core 102. The throughbore 314 can also include internal structure for rotationally guiding the elongate key 180 into the keyway 320. For example, in one embodiment, the structure for providing rotational guidance can include a pair of helical shoulders 322 that rotate in opposite helical directions about the longitudinal axis 324 in a direction from the first end 316 to the second end 318 of the converter body 304. In certain examples, the shoulders 322 and keyway 320 can provide for rotational guidance of the converter 300 relative to the connector core 102 along a rotational movement of at least 90°, or at least 135°, or at least 170°, or up to at least 180°. As best depicted in FIG. 10, the second end 318 of the converter body 304 can define a notched portion 338, which in some embodiments can be in the form of a generally V-shaped channel configured to interact with the dust cap 308, as discussed in more detail below.

With continued reference to FIG. 10, an exterior radial surface 340 of the converter body 304 can define a channel 342, positioned between the first end 316 and the second end 318, into which the O-ring 306 can optionally be seated. In some embodiments, the O-ring 306 can generally be configured to create an environmental seal between the exterior radial surface 340 of the converter body 304 and the interior bore 204 of the fiber-optic connector 200, thereby inhibiting the intrusion of water and other contaminants into the interior bore 204 of the fiber-optic connector 200.

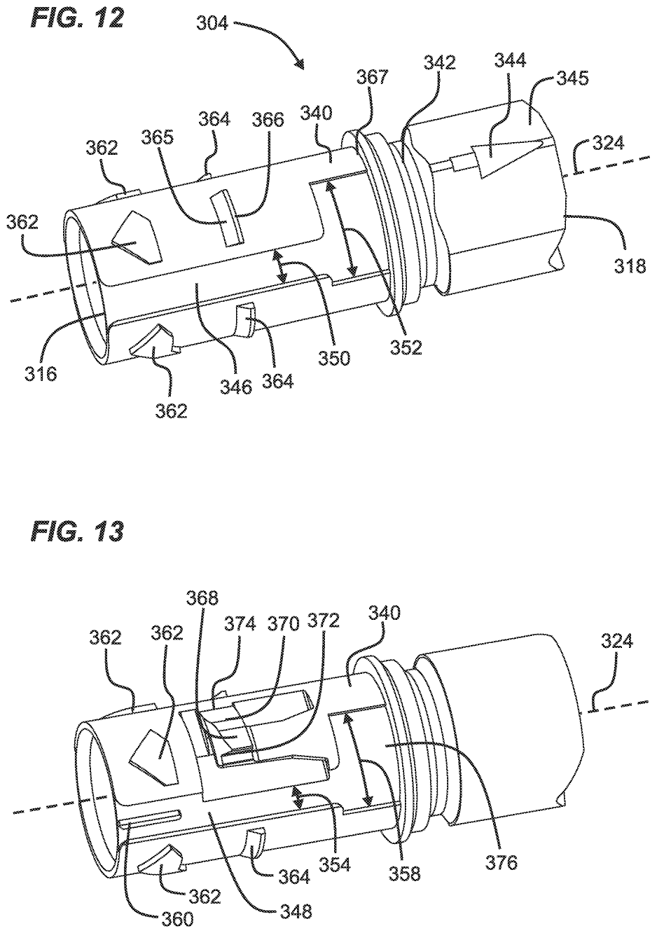

As best depicted in FIG. 12, in some embodiments the exterior radial surface 340 of the converter body 304 can define an alignment indicator portion 344 (e.g., arrow), which can be used to aid in alignment when operably coupling the converter 300 to the fiber-optic plug 100, and when operably coupling the converter 300 (and fiber-optic plug 100) to the fiber-optic connector 200. As depicted, the alignment indicator portion 344 can be positioned between the second end 318 and the channel 342; although other positions of the arrow portion 344 are also contemplated. When coupling the converted 300 to the fiber-optic receptacle 200, the alignment indicator portion 344 can be aligned with the notch 210 of the receptacle 200, thereby aligning the keyed surface 345 of the converter relative to the corresponding keyed receptacle defined on the interior bore 204 of the fiber-optic receptacle 200.

With continued reference to FIGS. 12-13, in some embodiments, the exterior radial surface 340 of the converter body 304 can define first and second guide slots 346, 348, which in some embodiments can be positioned on opposing sides of the exterior radial surface 340 from one another. In embodiments, the first guide slot 346 can traverse between the first end 316 and the channel 342 defined by the exterior radial surface 340, wherein the first guide slot 346 is defined by a first width 350 and a second width 352, with the second width 352 being generally larger than the first width 350, and being positioned generally further from the first end 316 than the first width 350.

The second guide slot 348 can be similar to the first guide slot 346, in that the second guide slot 348 can traverse between the first end 316 and the channel 342 defined by the exterior radial surface 340, wherein the second guide slot 348 is defined by a first width 354 and a second width 356, with the second width 356 being generally larger than the first width 354, and being positioned generally further from the first end 316 than the first width 354. In some embodiments, the second width 352, 356 of both the first and second guide slots 346, 348 can generally extend less than about 90° around the circumference of the exterior radial surface 340. For example, in some embodiments, the second width 352, 356 can extend between about 45° and about 60° around the circumference of the exterior radial surface 340. In some embodiments, one or more guide fins 360 can be defined within either of the first and second guide slots 346, 348.

With continued reference to FIGS. 12-13, in some embodiments, the exterior radial surface 340 of the converter body 304 can define one or more axial stops 362 (e.g., triangular projections, etc.) configured to establish axial retention between the converter 300 and the fiber-optic plug 100. As depicted, in some embodiments the converter body 304 can define four axial stops 362 equally radially spaced apart along the exterior radial surface 340 in proximity to the first end 316 of the converter body 304.

The exterior radial surface 340 of the converter body 304 can define one or more tabs 364 extending radially outward from the exterior radial surface 340, which in some embodiments can include a ramp surface 365 and one or more first stop surfaces 366. As depicted, in some embodiments, the converter body can define three tabs 364 spaced apart along the exterior radial surface 340, generally between the axial stops 362 and the channel 342, such that the ramp surface 365 is positioned closer to the first end 316, and the first stop surfaces 366 are positioned between the ramp surface 365 and the channel 342. In some embodiments, the three tabs 364 can generally be aligned with three of the four axial stops 362, along a longitudinal axis of the converter body 304. In some embodiments, a second stop surface 367 can further be defined by the exterior radial surface 340. For example, in some embodiments, the second stop surface 367 can be positioned between the channel 342 and the first stop surfaces 366.

As best depicted in FIG. 13, in some embodiments, the converter body 304 can define a resilient snap fit member 368, which in some embodiments can include a ramp portion 370 and a stop portion 372. In some embodiments, the resilient snap fit member 368 can be a cantilevered member operably coupled to the exterior radial surface 340 at a first connection 374 adjacent to the ramp portion 370, and a second connection 376 oriented substantially orthogonally to the first connection 374. Accordingly, in some embodiments, the first connection 374 can generally join the resilient snap fit member 368 to the exterior radial surface 340 in a circumferential direction, while the second connection 376 can generally join the resilient snap fit member 368 to the exterior radial surface 340 in a direction substantially orthogonal to the circumferential direction (e.g., aligned with a longitudinal axis 324 of the converter body 304).

In embodiments, the resilient snap fit member 368 can flex relative to the exterior radial surface 340, thereby enabling an external force acting on the ramp portion 370 to deflect the resilient snap fit member 368 inwardly. As in the case of rotation, the external force can pass over the stop portion 372, such that no external force continues to act on the resilient snap fit member 368, thereby causing the resilient snap fit member to resume its original shape, to inhibit back rotation of the converter body 304.

Accordingly, in some embodiments, the converter body 304 can define two distinct interlock functions compatible with features defined by the fiber-optic plug 100, including a first interlock function defined by one or more stops (e.g., triangular projections, etc.) configured to establish axial retention between the fiber-optic plug 100 and the converter 300, and a second interlock function defined by a resilient snap fit member 368 configured to inhibit rotation between the fiber-optic plug 100 and the converter 300.

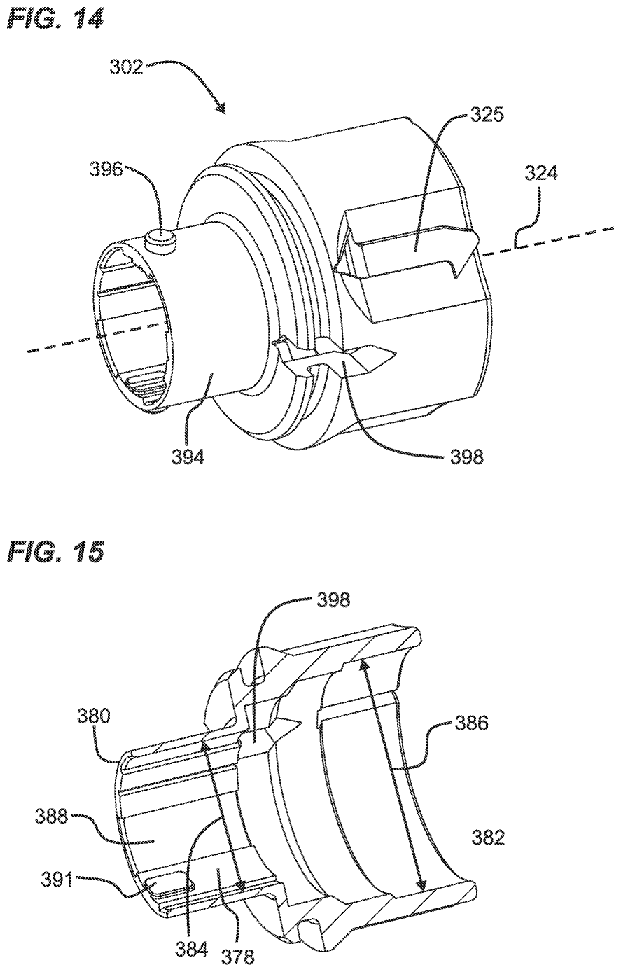

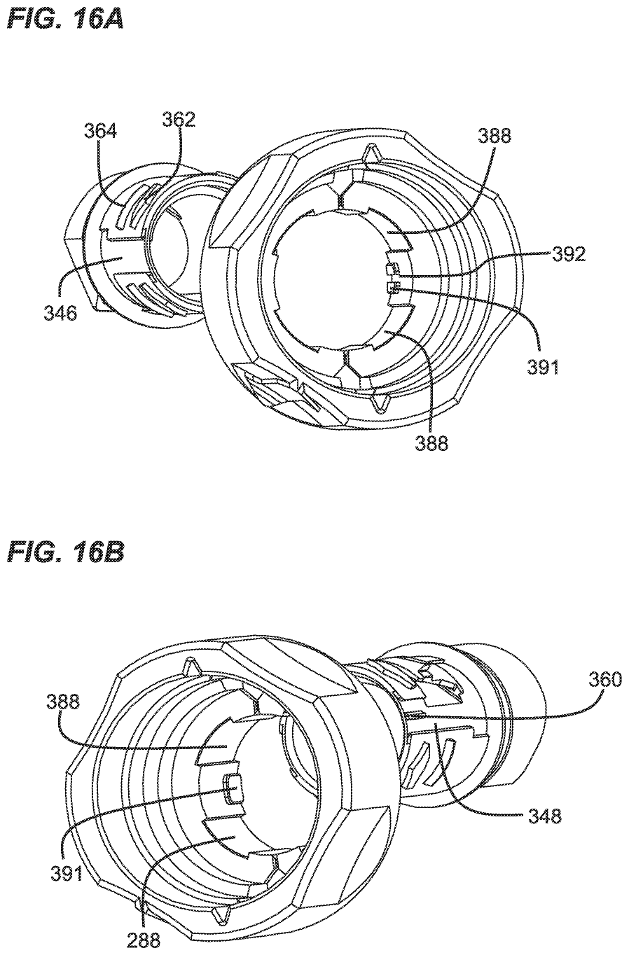

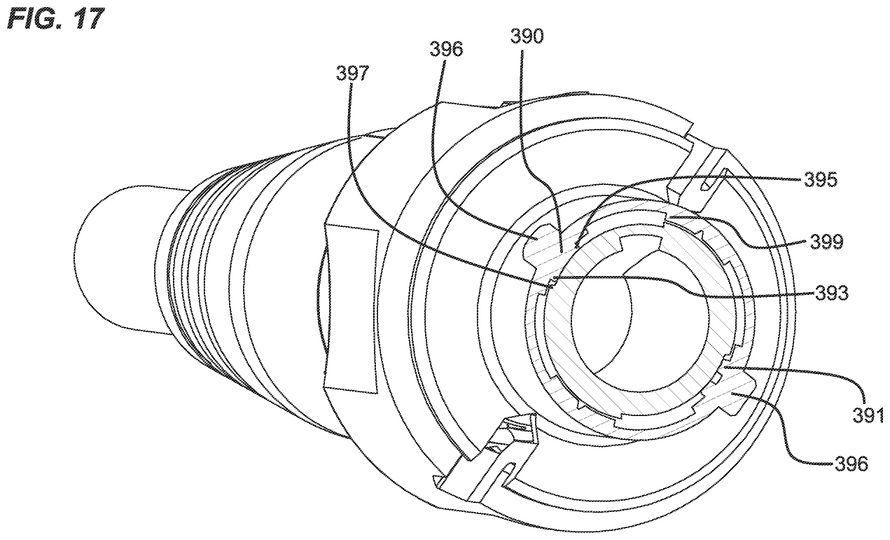

With additional reference to FIGS. 14-15, the converter nut 302 can define a throughbore 378 extending between a first end 380 and a second end 382. An interior surface of the throughbore 378 can generally be shaped to receive the converter body 304. For example, as further depicted in FIGS. 16-17, the throughbore 378 can be substantially cylindrical in shape, having a first diameter portion 384 configured to receive a portion of the converter body 304 and a second diameter portion 386 configured to receive at least a portion of the fiber-optic plug 100.

In some embodiments, various features defined by the interior surface of the throughbore 378 can interact with one or more features defined by the exterior radial surface of the converter body 304. For example, in some embodiments, the interior surface of the throughbore 378 can define one or more channels 388 configured to enable the axial stops 362 and tabs 364 of the converter body 304 to pass therethrough. Further, in some embodiments, the interior surface of the throughbore 378 can define one or more guide members 390, 391 configured to be received within the first guide slot 346 and the second guide slot 348 defined by the exterior radial surface 340 of the converter body 304. In some embodiments, at least one of the guide members 391 can define a slot 392 configured to enable guide fin 360 defined by the exterior radial surface 340 of the converter body 304 to pass therethrough.

In some embodiments, the guide members 390, 391 can have a width substantially equal to the first width 350, 354 of the first and second guide slots 346, 348, thereby inhibiting rotation of the converter nut 302 relative to the converter body 304, when the converter body 304 is initially inserted into the throughbore 378 of the converter nut 302. Once the guide members 390, 391 passed entirely through the first width 350, 354 portion of the first and second guide slots 346, 348, and into the second width 352, 358 portion of the first and second guide slots 346, 348, the guide members 390, 391 can move within the second width 352, 358 portion of the first and second guide slots 346, 348, thereby enabling limited rotation of the converter nut 302 relative to the converter body 304.

With additional reference to FIG. 17, a cross-sectional view depicting an interaction between the converted body 304 and the converter nut 302 is depicted in accordance with an embodiment of the disclosure. As depicted, the guide members 390, 391 can be positioned on an interior surface of the throughbore 378 such that the guide members 390, 391 are radially aligned with the coupling pins 396. With specific reference to guide member 390, each of the guide members can include a first stop 393 and a second stop 395, which upon rotation can come into abutting contact with a corresponding third stop 397 and fourth stop 399 of the first guide slot 346.

Accordingly, the maximum angular rotation of the converter nut 302 relative to the converter body 304 can be established by the second width 352, 358 portion of the first and second guide slots 346, 348 as well as the dimensions of the guide members 390, 391. For example, in some embodiments, the second width 352, 356 can extend about between about 50° and about 60° around the circumference of the exterior radial surface 340, thereby limiting rotation of the converter nut 302 relative to the converter body 304 to a similar range. For example, in one embodiment, rotation of the converter nut 302 relative to the converter body 304 is limited to about 54°/+/−5°, wherein the converter nut 302 is aligned relative to the converter body 304 when the converter nut 302 is within 5° of a desired rotation angle relative to the converter body 304 (e.g., alignment to a particular angle equals the angle +/−5°).

In some embodiments, the tabs 364 defined by the exterior radial surface 340 of the converter body 304 can deform slightly when the converter body 304 is initially inserted into the throughbore 378 of the converter nut 302. For example, an external pressure applied to the ramp surface 365 of the tabs 364 can cause the tabs 364 to temporarily deform, enabling the tabs 364 to pass through the channels 388 defined on the interior surface of the throughbore 378. Upon reaching the first end 380 of the converter nut 302, and the external pressure on the tabs 364 is removed, the tabs 364 can resume their original shape, such that the first stop surfaces 366 of the tabs 364 inhibit passage of the tabs 364 back through the channels 388. Thereafter, the first diameter portion 384 of the throughbore 378 can be confined between the first stop surfaces 366 and the second stop surfaces 367, so as to limit movement of the converter nut 302 relative to the converter body 304 along the longitudinal axis 324.

With continued reference to FIG. 14, an exterior radial surface 394 of the converter nut 302 can define one or more coupling pins 396, which in some embodiments can extend radially outward from the exterior radial surface 394 to enable coupling of the converter nut 302 with the bayonet coupling provided by the fiber-optic connector 200. In particular, the one or more coupling pins 396 can be shaped and sized to fit within the bayonet slots 212 of the fiber-optic connector 200, thereby enabling the converter nut 302 to be selectively secured to the fiber-optic connector 200. To aid in alignment of the converter nut 302 relative to the fiber-optic connector 200, in some embodiments, an alignment indicator portion 325 can be positioned on an exterior of the converter nut 302, such that the alignment indicator portion 325 aligns with the notch 210 of the fiber-optic receptacle 200 when the one or more coupling pins 396 are fully seated within the bayonet slots 212. Accordingly, in some embodiments, the alignment indicator portion 325 can be radially aligned with at least one of the stops 397, 399 of the guide slots 346, 348.

As best depicted in FIG. 14, the exterior radial surface 394 of the converter nut 302 can define one or more breakaway channels 398, which in some embodiments can pass entirely through the wall of the converter nut 302 from the exterior radial surface 394 to the interior surface of the throughbore 378. In some embodiments, the one or more breakaway channels 398 can define a materially weakened breakpoint of the converter nut 302, such that insertion of a pry tool into the one or more breakaway channels 398 can cause the converter nut 302 to break in half, thereby enabling the converter nut 302 to be readily separated from the converter body 304. For example, in some embodiments, a portion of the dust cap 308 can be inserted into the one or more breakaway channels 398 to initiate the breakage.

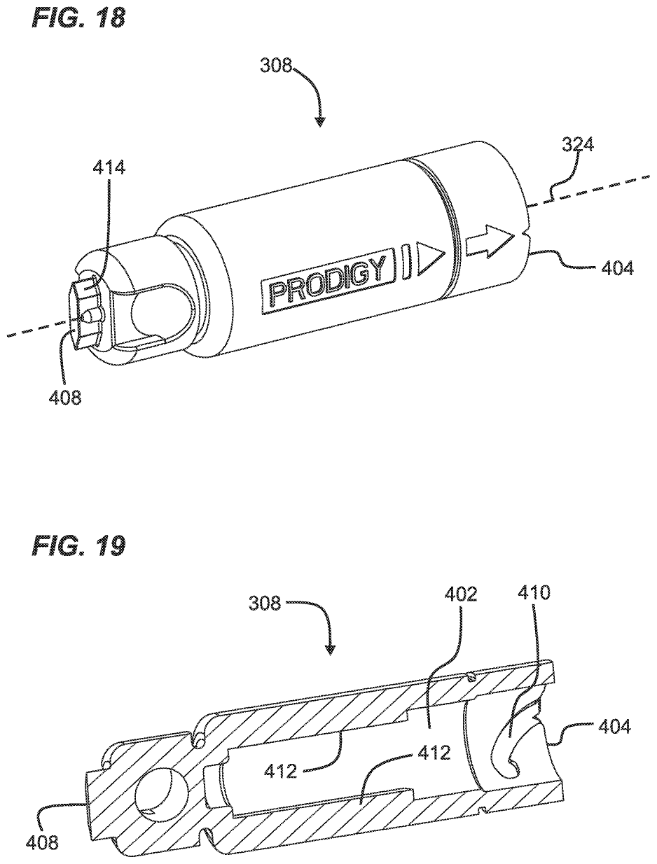

With reference to FIGS. 18-19, the dust cap 308 can define a blind bore 402 extending from a first end 404 towards a second end 408 generally configured to receive at least a portion of the converter nut 302 and converter body 304, wherein the blind bore 402 does not pass entirely through the dust cap 308 to the second end 408. As depicted in FIG. 17, in some embodiments, an interior surface of the blind bore 402 can define one or more bayonet slots 410 configured to receive coupling pins 396 of the converter nut 302, thereby enabling the dust cap 308 to be selectively secured to the converter nut 302.

As further depicted in FIG. 19, in some embodiments, the interior surface of the blind bore 402 can define one or more alignment projections 412 configured to interact with the notched portion 338 defined by the second end 318 of the converter body 304, such that insertion of the converter body 304 into the blind bore 402 causes the alignment projections 412 to interact with the notch portion 338 of the converter body 304, thereby rotating the converter body 304 until the alignment projections 412 reside within the bottom of the notch portion 338, thereby ensuring proper alignment of the converter body 304 relative to the converter nut 302 and dust cap 308.

As best depicted in FIG. 18, in some embodiments, the second end 408 of the dust cap 308 can define a pry tool 414, which can be selectively inserted into the one or more breakaway channels 398 of the converter nut 302 to initiate the breakage. In embodiments, the dust cap 308 can be tethered to the converter nut 302 with lanyard 310.

The converter 300 can be used when it is desired to optically couple the fiber-optic plug 100 to the otherwise noncompatible fiber-optic connector 200. In particular, the fiber-optic plug 100 can be inserted into the converter 300 (such that the converter 300 resides on the fiber-optic plug 100), thereby establishing a new profile of the fiber-optic plug 100/converter 300 assembly that is compatible with the receptacle of the fiber-optic connector 200.

In some embodiments, the converter 300 can be secured to the fiber-optic plug 100 by an interaction between features defined by the turn-to-secure fastener 112 of the fiber-optic plug 100 and features defined by the converter body 304 of the converter 300. In particular, the axial stops 362 defined along the exterior radial surface 340 of the converter body 304 can be captured by the stop receptacles 115 defined by the interior surface of the turn-to-secure fastener 112, wherein insertion of a portion of the converter body 304 into the bore defined by the turn-to-secure fastener 112, and subsequent rotation of the converter body 304 relative to the turn-to-secure fastener 112 inhibits axial movement of the converter body 304 relative to the turn-to-secure fastener 112.

In some embodiments, back rotation of the converter body 304 relative to the turn-to-secure fastener 112 can be inhibited by an interaction between the resilient snap fit member 368 and the snap fit receptacles 113 of the turn-to-secure fastener 112. In particular, partial rotation of the converter body 304 relative to the turn-to-secure fastener 112 can cause the resilient snap fit member 368 to deflect inwardly as the ramp portion 370 of the resilient snap fit member 368 contacts corresponding portions of the snap fit receptacles 113. As the converter body 304 continues to rotate, the external force acting the resilient snap fit member 368 can pass over the stop portion 372, thereby causing the resilient snap fit member to resume its original shape. Thereafter, interference between the stop portion 372 and the snap fit receptacles 113 of the turn-to-secure fastener inhibit back rotation of the converter body 304 relative to the turn-to-secure fastener 112.

To affect release of the converter body 304 from the turn-to-secure fastener 112, a user can press on a portion of the resilient snap fit member 368 extending distally beyond the turn-to-secure fastener 112. Because the resilient snap fit member 368 is generally located within the throughbore 378 of the converter nut 302, in some embodiments, the converter nut 302 must be broken to separate the converter nut 302 from the converter body 304 in order to gain access to the resilient snap fit member 368. Accordingly, in some embodiments, the converter nut 302 defines one or more breakaway channels 398 configured to ease in separation of the converter nut 302 from the converter body 304.

With the converter 300 installed on the fiber-optic plug 100, the dust cap 308 can be removed, and the fiber-optic plug 100/converter 300 assembly can be inserted into the interior bore 204 of the fiber-optic connector 200. In some embodiments, the arrow portion 344 defined by the converter body 304 can aid in alignment of the fiber-optic plug 100/converter 300 assembly relative to the fiber-optic connector 200. In particular, the coupling pins 396 of the converter nut 302 can be aligned with the bayonet slots 212 of the fiber-optic connector 200. Thereafter, the fiber-optic plug 100/converter 300 assembly can be inserted slightly into the first end 206 of the connector body 202. Next, the converter nut 302 is rotated until the coupling pins 396 on the converter nut 302 align with the one or more bayonet slots 212 formed in the first end 206 of the interior bore 204. The fiber-optic plug 100/converter 300 assembly is then pushed forward into the fiber-optic connector 200 until the coupling pins 396 bottom in the bayonet slots 212, and the converter nut 302 can no longer be rotated.

Accordingly, when converter 300 is operably coupled to a fiber-optic plug 100 having a first keyed profile, the first keyed profile of the fiber-optic plug 100 is converted into a second keyed profile compatible with fiber-optic receptacle 200, thereby enabling the fiber-optic plug 100 to be optically connected to the fiber-optic receptacle 200 such that the fiber-optic cables housed therein are optically aligned to provide an optical connection. In embodiments, the fiber-optic plug 100 and fiber-optic receptacle 200 can be ruggedized (e.g., fit for outside use with the potential exposure to moisture and other contaminants) or non-ruggedized.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. An optical plug connector, comprising:
a core at least partially housing a fiber-optic cable ferrule, an exterior surface of the core defining a first radially oriented stop surface and a second radially oriented stop surface; and
a coupling nut rotationally coupled to the core, an interior surface of the coupling nut defining a third radially oriented stop surface and a fourth radially oriented stop surface,
wherein the coupling nut is limited in its rotation relative to the core between a first rotational position and a second rotational position, wherein the first rotational position is defined by abutting contact between the first radially oriented stop surface of the core and the third radially oriented stop surface of the coupling nut, and wherein the second rotational position is defined by abutting contact between the second radially oriented stop surface of the core and the fourth radially oriented stop surface of the coupling nut, wherein an exterior surface of the coupling nut defines a pair of radially extending coupling pins.

2. The optical plug connector of claim 1, wherein the exterior surface of the core defines a keyed surface.

3. The optical plug connector of claim 2, wherein the exterior surface of the core includes an alignment indicator configured to aid a user in identifying an orientation of the keyed surface of the core.

4. The optical plug connector of claim 3, wherein in the first rotational position, one radial extending coupling pin defined on an exterior surface of the coupling nut is axially aligned with the alignment indicator defined by the exterior surface of the core.

5. The optical plug connector of claim 4, wherein the coupling nut is rotatable relative to the core by about 54° between the first rotational position and the second rotational position.

6. A converter for an optical plug, comprising:
a converter body positionable at least partially over a plug connector, an exterior surface of the converted body defining a first radially oriented stop surface and a second radially oriented stop surface; and
a converter nut rotationally coupled to the converter body, an interior surface of the converter nut defining a third radially oriented stop surface and a fourth radially oriented stop surface,
wherein the converter nut is limited in its rotation relative to the converter body between a first rotational position and a second rotational position, wherein the first rotational position is defined by abutting contact between the first radially oriented stop surface of the converter body and the third radially oriented stop surface of the converter nut, and wherein the second rotational position is defined by abutting contact between the second radially oriented stop surface of the converter body and the fourth radially oriented stop surface of the converter nut.

7. The converter of claim 6, wherein an exterior surface of the converter nut defines a pair of radially extending coupling pins.

8. The converter of claim 6, wherein the exterior surface of the converter body defines a keyed surface.

9. The converter of claim 8, wherein the exterior surface of the converter body includes an alignment indicator configured to aid a user in identifying an orientation of the keyed surface of the converter body.

10. The converter of claim 9, wherein in the first rotational position, one radial extending coupling pin defined on an exterior surface of the converter nut is axially aligned with the alignment indicator defined by the exterior surface of the converter body.

11. The converter of claim 10, wherein the converter nut is rotatable relative to the converter body by about 54° between the first rotational position and the second rotational position.

12. The converter of claim 6, further comprising a dust cap.

13. The converter of claim 12, wherein the dust cap defines one or more bayonet slots configured to receive coupling pins of the converter nut to rotationally orient the converter nut relative to the dust cap.

14. The converter of claim 12, wherein the dust cap defines one or more alignment projections configured to interface with the notch portion of the converter body to rotationally orient the converter body relative to the dust cap.

15. The converter of claim 14, wherein the converter is operably coupleable to a fiber-optic plug to convert the fiber-optic plug from a first keyed profile to a second keyed profile.

16. A converter for an optical plug, comprising:
a converter body having an outer surface defining a guide slot extending along a longitudinal axis of the converter body, the guide slot defined by a first radial width portion and a second radial width portion; and
a converter nut defining a through bore through which a portion of the converter body passes to enable the converter nut to rotate relative to the converter body, wherein an interior surface of the throughbore defines an inwardly extending guide member, the guide member confined to the guide slot defined by the converter body when the converter nut is operably coupled to the converter body, whereupon positioning the guide member within the second radial width portion of the guide slot limits rotation of the converter nut relative to the converter body to an angle of less than 90°.

17. The converter of claim 16, further comprising a dust cap.

18. The converter of claim 17, wherein the dust cap defines one or more bayonet slots configured to receive coupling pins of the converter nut to rotationally orient the converter nut relative to the dust cap.

19. The converter of claim 17, wherein the dust cap defines one or more alignment projections configured to interface with the notch portion of the converter body to rotationally orient the converter body relative to the dust cap.

20. The converter of claim 16, wherein the converter is operably coupleable to a fiber-optic plug to convert the fiber-optic plug from a first keyed profile to a second keyed profile.

21-35. (canceled)
